(19) United States
(12) Patent Application Publication
(10) Pub. No.: US 2014/0272430 A1
(43) Pub. Date: Sep. 18, 2014

(54) PROCESS OF MAKING DISPERSED POLYETHERIMIDE MICRONIZED PARTICLES AND PROCESS OF COATING AND FURTHER FORMING OF THESE PARTICLES PRODUCTS MADE THEREFROM

(71) Applicant: SABIC INNOVATIVE PLASTICS IP B.V., Bergen op Zoom (NE)

(72) Inventor: Nathan Kalayaraman, Mt. Vernon, IN (US)

(73) Assignee: SABIC INNOVATIVE PLASTICS IP B.V., Bergen op Zoom (NE)

(21) Appl. No.: 13/843,010

(22) Filed: Mar. 15, 2013

(51) Int. Cl. C09D 7/12

(52) U.S. Cl. CPC C09D 7/1233
USPC 428/435; 524/161; 524/104; 524/113; 524/154; 524/147; 428/458; 428/473.5; 427/385.5

(57) ABSTRACT

Processes involving wetting fibers with an aqueous dispersion of micronized thermoplastic powders; processes for producing an aqueous dispersion of micronized thermoplastic powders; processes of chemically surface cross-linking micronized particles; and articles of produced therefrom.

### BACKGROUND OF THE INVENTION

1. Field of the Invention

The invention relates generally to thermoplastic coatings and thin films, and more specifically to methods of producing coatings and thin films from aqueous dispersions of micronized thermoplastic powders and optionally chemically cross-linking the coatings and articles produced therefrom.

2. Description of the Related Art

Themoplastic polymers such as polyetherimide (PEI) and polyethersulfone (PES) are commonly used as a protective layer (fibers, glass, metal, etc) to impart insulation, protection against environmental conditions and also in making thermoplastic composites (TC). Currently, different methods are used to coat materials with these high performance polymers. Melt processes can be employed, where the articles are coated with molten polymer and later cooled. Melt processes disadvantageously involve significant capital investments and also provide poor wetting of the polymer melt to the article, producing voids in the surface of the coated article. Solution impregnation processes can be employed, where the articles are wetted by a polymer dissolved in an organic solvent, followed by subsequent removal of the solvents. Solution impregnation process disadvantageously release of volatile organic compounds. Powder impregnation processes can be employed, where articles are electrostatically coated with ground polymer powders and later melted to form the polymer coating. The high costs of grinding as well as presence of impurities during grinding are disadvantages of this powder impregnation processes. There is an unmet need for a method to produce thermoplastic coatings by solution impregnation without the use of organic solvents.

Thermoplastic polymers such as polyetherimide (PEI) and polyethersulfone (PES) are commonly used as films as well as protective layers due to their excellent mechanical, dielectric and high heat properties. These polymers are also used commonly as a tie layer in cookware. An organic solvent based coating process is commonly used in the industry to form films and to make coatings. Disadvantages of this organic solvent based coating process are the release of volatile organic compounds, as well as high viscosity of the polymer solution. There is an unmet need for a method to make the films and coatings using water dispersed formulations, which have lower volatile organic compound (VOC) emission, as well as reduced viscosity.

Polyetherimide (PEI) is a thermoplastic polymer with high heat resistance and superior flame resistance properties, but the chemical resistance properties of PEI are not as good as the thermoset polymers. There is an unmet need for a cross-linked micronized powder and articles of PEI, which will enhance the chemical resistance properties.

### BRIEF SUMMARY OF THE INVENTION

A first embodiment meets the need for a method to produce thermoplastic coatings by solution impregnation without the use of organic solvents. The first embodiment provides an innovative process, which involves wetting the fibers with an aqueous dispersion of micronized thermoplastic powders, having a substantially spherical morphology and an average particle diameter of less than or equal to 45 microns, and later forming the high performance polymer coating by heating at greater than or equal to 300 degrees Celsius for at least 15 minutes. This process does not involve volatile organic compounds and results in good interfacial adhesion.

A second embodiment meets the need for a method to make the films and coatings using water dispersed formulations, which have lower volatile organic compound (VOC) emission, as well as reduced viscosity. The second embodiment provides innovative process for producing an aqueous dispersion of micronized thermoplastic powders. The micronized thermoplastic powders can have a spherical morphology and an average particle diameter of less than or equal to 75 microns. The aqueous dispersion of the micronized thermoplastic powders can contain a coalescing agent. The final formulation can form a protective coating or a continuous film during the drying process at temperatures less than or equal to 100 degrees Celsius.

A third embodiment meets the need for a cross-linked micronized powder and articles of PEI, which provide enhanced chemical resistance properties. The third embodiment provides an innovative process of chemically surface cross-linking micronized particles as well as articles of polyetherimide (PEI) resin. The surface cross-linking provides better chemical resistance properties without compromising thermal stability and provides better barrier properties.

### BRIEF DESCRIPTION OF THE DRAWINGS

These and other features, aspects, and advantages of the present invention will become better understood with reference to the following description and appended claims, and accompanying drawings where:

FIG. 1: shows a scanning electron microscope image of polyetherimide powder produced through an emulsion process;

FIG. 2: shows an optical microscope image of a copper wire coated with polyetherimide;

FIG. 3: shows a schematic diagram of one of the possible coating processes to produce high performance thermoplastic-coated articles;

FIG. 4: shows a schematic process diagram of making aqueous dispersion of high performance polymers;

FIG. 5: shows a scanning electron microscope image of a polyetherimide powder produced through emulsion process;

FIG. 6A: shows a polyetherimide micronized powder dissolved in methylene chloride (5% wt/wt);

FIG. 6B: shows micronized polyetherimide particles immersed in 10% (w/v) of diamine (PXDA) in methanol for one hour and later dissolved in methylene chloride (5% wt/wt)

FIG. 7: shows a thermo gravimetric analysis of micronized polyetherimide particles in air;

FIG. 8: shows a thermo gravimetric analysis of micronized polyetherimide particles in nitrogen; and

FIG. 9: shows a schematic process diagram of a process for producing surface cross-linked PEI coated wire/glass/fiber.

It should be understood that the various embodiments are not limited to the arrangements and instrumentality shown in the drawings.

### DETAILED DESCRIPTION OF THE INVENTION

The invention is directed to methods of making and utilizing micronized particles of thermoplastic polymers, copolymers and blends. Of particular interest are polymers of polyetherimide, polyethersulfone, their copolymers, and blends. The micronized particles can be made into coatings or thin films. In use the coating or thin films can be cross-linked enhancing the properties of the coatings or thin films. Composite and high performance articles can be made from aqueous dispersions of the micronized particles thereby avoiding the release of volatile organic components into the environment.

The present invention may be understood more readily by reference to the following detailed description of preferred embodiments of the invention as well as to the examples included therein. All numeric values are herein assumed to be modified by the term “about,” whether or not explicitly indicated. The term “about” generally refers to a range of numbers that one of skill in the art would consider equivalent to the recited value (i.e., having the same function or result). In many instances, the term “about” may include numbers that are rounded to the nearest significant figure.

A first embodiment relates to a process of making polyetherimide or polyethersulfone coated articles with aqueous dispersion of micronized polyetherimide or polyethersulfone polymers. The first embodiment involves producing polyetherimide (PEI) or polyethersulfone (PES) coated articles (glass, carbon, metal, etc.) by wetting the article through immersion in aqueous dispersion of micronized PEI or micronized PES, having a spherical morphology and particle diameter less than or equal to 45 microns, and later forming the coating by heating in an oven operated at greater than or equal to 300 degrees Celsius for greater than or equal to 15 minutes. This coating process does not involve any volatile organic content release and can produce a uniform coating of PEI or PES polymer on the article with good interfacial adhesion.

The scanning electron microscope (SEM) image shown in FIG. 1, illustrates the spherical nature of the particles 100. These particles had an average particle diameter of 18 microns as per light scattering data. An optical image of a coated wire 200 is shown in FIG. 2. The coating thickness illustrated is about 5.7 microns. Industrially, articles can be coated by this aqueous dispersion of high performance thermoplastic polymers as illustrated in FIG. 3. A spool 300 of fiber material 304 is provided. The fiber material 304 can be carbon fiber, glass fiber, or metal wire, such as a copper wire. The fiber material 304 can be feed through a tank 301 containing an aqueous dispersion of a thermoplastic polymer 305. The thermoplastic polymer 305 can be micronized polyetherimide, having an average particle diameter of less than or equal to 45 microns. After passing through the tank 301, the fiber material 304 is coated with an emulsion coating 306. The coated fiber material 304 can be passed through a heater 302 operated at a temperature of greater than or equal to 300 degrees Celsius to evaporate water 307. The retention time within the heater 302 can be greater than or equal to 15 minutes. Upon exiting the heater 302, a thermoplastic coated article 308 can be wound onto a final spool 303.

A second embodiment relates to a process of making water dispersed high performance polymers that can form continuous film at a temperature of less than or equal to 100 degrees Celsius. The second embodiment involves producing water-dispersed polyetherimide (PEI) or polyethersulfone (PES) polymers. These water-dispersed polymer formulations can coalesce to form a continuous film by drying at a temperature of less than or equal to 100 degrees Celsius.

Referring to FIG. 4, thermoplastic polymer pellets 404, such as polyetherimide pellets can be feed into a vessel 400 along with an organic solvent 403, such as methylene chloride. For example, a 20% w/w polyetherimide (ULTEM® 1000 resin) solution in methylene chloride can be prepared in vessel 400. After agitation in vessel 400, the solution can be fed to a high shear agitator 401, where a surfactant 419, such as sodium dodecyl sulfonate, and de-ionized water 418 can also be added. More specifically, 3 times de-ionized water can also be added to this polymer solution (based on methylene chloride weight) along with 3 weight percent of sodium dodecyl benzene sulfonate surfactant, based on polyetherimide weight. The resulting solution can be emulsified using the homogenizer 411, specifically, a Silverson Model L4R-PA at 2500 rpm or more. Agitation in agitator 401 can result in a stable emulsion. A homogenizer 411 can recycle a portion of the off-stream of the agitator 401. The resulting stable emulsion can be fed into a spray drying vessel 402. A gas 410, such as nitrogen or air, can be added to the spray drying vessel 402 along with water 412. Methylene chloride can be removed from the emulsion by spray drying in spray drying vessel 402. The spray drying vessel can be operated at 80 degrees Celsius, and the resulting aqueous dispersion can be maintained at 80 degrees Celsius for three hours in order to remove any remaining amount of volatile organic compounds (VOCs). The VOCs can be recovered in a condenser 409, a decanter 407, having a vent 406. The solvent, such as methylene chloride, can be recycled from the decanter 407 to the vessel 400 via stream 408, while waste water stream 405 can be removed. Finally, the spray dried materials can be recovered from the spray drying vessel 402 and passed through a centrifuge 414 in the presence of water 413, which can be sent to a waste water stream 415. Micronized particles can be recovered from the centrifuge and passed through a dryer 416 at a temperature of less than or equal to 100 degrees Celsius and ultimately recovered as a thermoplastic polymer powder having a spherical morphology and an average particle diameter of less than or equal to 45 microns. The scanning electron microscope (SEM) image shown in FIG. 5, illustrates the spherical nature of the formed polymer particles 500.

The polyetherimide can be selected from polyetherimide homopolymers, e.g., polyetherimides, polyetherimide co-polymers, e.g., polyetherimide sulfones, and combinations thereof. Polyetherimides are known polymers and are sold by SABIC Innovative Plastics under the ULTEM™, EXTEM™, and SILTEM™ brands (Trademark of SABIC Innovative Plastics IP B.V.).

In one embodiment, the polyetherimides are of formula (1):

[chemical structure]

wherein a is more than 1, for example 10 to 1,000 or more, or more specifically 10 to 500.

The group V in formula (1) is a tetravalent linker containing an ether group (a “polyetherimide” as used herein) or a combination of an ether groups and arylene sulfone groups (a “polyetherimide sulfone”). Such linkers include but are not limited to: (a) substituted or unsubstituted, saturated, unsaturated or aromatic monocyclic and polycyclic groups having 5 to 50 carbon atoms, optionally substituted with ether groups, arylene sulfone groups, or a combination of ether groups and arylene sulfone groups; and (b) substituted or unsubstituted, linear or branched, saturated or unsaturated alkyl groups having 1 to 30 carbon atoms and optionally substituted with ether groups or a combination of ether groups, arylene sulfone groups, and arylene sulfone groups; or combinations comprising at least one of the foregoing. Suitable additional substitutions include, but are not limited to, ethers, amides, esters, and combinations comprising at least one of the foregoing.

The R group in formula (1) includes but is not limited to substituted or unsubstituted divalent organic groups such as: (a) aromatic hydrocarbon groups having 6 to 20 carbon atoms and halogenated derivatives thereof; (b) straight or branched chain alkylene groups having 2 to 20 carbon atoms; (c) cycloalkylene groups having 3 to 20 carbon atoms, or (d) divalent groups of formula (2):

[chemical structure]

wherein Q¹ includes but is not limited to a divalent moiety such as —O—, —S—, —C(O)—, —SO₂—, —SO—, —C_{y}H_{2y}— (y being an integer from 1 to 5), and halogenated derivatives thereof, including perfluoroalkylene groups.

In an embodiment, linkers V include but are not limited to tetravalent aromatic groups of formula (3):

[chemical structure]

wherein W is a divalent moiety including —O—, —SO₂—, or a group of the formula —O—Z—O— wherein the divalent bonds of the —O— or the —O—Z—O— group are in the 3,3′, 3,4′,4,3′, or the 4,4′ positions, and wherein Z includes, but is not limited, to divalent groups of formulas (4):

[chemical structure]

wherein Q includes, but is not limited to a divalent moiety including —O—, —S—, —C(O), —SO₂—, —SO—, —C_{y}H_{2y}— (y being an integer from 1 to 5), and halogenated derivatives thereof, including perfluoroalkylene groups.

In a specific embodiment, the polyetherimide comprise more than 1, specifically 10 to 1,000, or more specifically, 10 to 500 structural units, of formula (5):

[chemical structure]

wherein T is —O— or a group of the formula —O—Z—O— wherein the divalent bonds of the —O— or the —O—Z—O— group are in the 3,3′,3,4′,4,3′, or the 4,4′ positions; Z is a divalent group of formula (3) as defined above; and R is a divalent group of formula (2) as defined above.

In another specific embodiment, the polyetherimide sulfones are polyetherimides comprising ether groups and sulfone groups wherein at least 50 mole % of the linkers V and the groups R in formula (1) comprise a divalent arylene sulfone group. For example, all linkers V, but no groups R, can contain an arylene sulfone group; or all groups R but no linkers V can contain an arylene sulfone group; or an arylene sulfone can be present in some fraction of the linkers V and R groups, provided that the total mole fraction of V and R groups containing an aryl sulfone group is greater than or equal to 50 mole %.

Even more specifically, polyetherimide sulfones can comprise more than 1, specifically 10 to 1,000, or more specifically, 10 to 500 structural units of formula (6):

[chemical structure]

wherein Y is —O—, —SO₂—, or a group of the formula —O—Z—O— wherein the divalent bonds of the —O—, SO₂—, or the —O—Z—O— group are in the 3,3′,3,4′,4,3′, or the 4,4′ positions, wherein Z is a divalent group of formula (3) as defined above and R is a divalent group of formula (2) as defined above, provided that greater than 50 mole % of the sum of moles Y+moles R in formula (2) contain —SO₂— groups.

It is to be understood that the polyetherimides and polyetherimide sulfones can optionally comprise linkers V that do not contain ether or ether and sulfone groups, for example linkers of formula (7):

[chemical structure]

Imide units containing such linkers are generally be present in amounts ranging from 0 to 10 mole % of the total number of units, specifically 0 to 5 mole %. In one embodiment no additional linkers V are present in the polyetherimides and polyetherimide sulfones.

In another specific embodiment, the polyetherimide comprises 10 to 500 structural units of formula (5) and the polyetherimide sulfone contains 10 to 500 structural units of formula (6).

In one embodiment, the polyetherimides include a polyetherimide thermoplastic resin composition, comprising: (a) a polyetherimide resin, and (b) a phosphorus-containing stabilizer, in an amount that is effective to increase the melt stability of the polyetherimide resin, wherein the phosphorus-containing stabilizer exhibits a low volatility such that, as measured by thermogravimetric analysis of an initial amount of a sample of the phosphorus-containing stabilizer, greater than or equal to 10 percent by weight of the initial amount of the sample remains unevaporated upon heating of the sample from room temperature to 300° C. at a heating rate of a 20° C. per minute under an inert atmosphere. In one embodiment, the phosphorous-containing stabilizer has a formula P—Rₐ, where R′ is independently H, alkyl, alkoxy, aryl, aryloxy, or oxy substituent and a is 3 or 4. Examples of such suitable stabilized polyetherimides can be found in U.S. Pat. No. 6,001,957, incorporated herein in its entirety.

The polyetherimide and polyetherimide sulfones can be prepared by various methods, including, but not limited to, the reaction of a bis(phthalimide) for formula (8):

[chemical structure]

wherein R is as described above and X is a nitro group or a halogen. Bisphthalimides (8) can be formed, for example, by the condensation of the corresponding anhydride of formula (9):

[chemical structure]

wherein X is a nitro group or halogen, with an organic diamine of the formula (10):

H₂N—R—NH₂ (10),

wherein R is as described above.

Illustrative examples of amine compounds of formula (10) include: ethylenediamine, propylenediamine, trimethylenediamine, diethylenetriamine, triethylenetetramine, hexamethylenediamine, heptamethylenediamine, octamethylenediamine, nonamethylenediamine, decamethylenediamine, 1,12-dodecanediamine, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylenediamine, 2,5-dimethylheptamethylenediamine, 2,2-dimethylpropylenediamine, N-methyl-bis(3-aminopropyl)amine, 3-methoxyhexamethylenediamine, 1,2-bis(3-aminopropoxy) ethane, bis(3-aminopropyl) sulfide, 1,4-cyclohexanediamine, bis-(4-aminocyclohexyl) methane, m-phenylenediamine, p-phenylenediamine, 2,4-diaminotoluene, 2,6-diaminotoluene, m-xylylenediamine, p-xylylenediamine, 2-methyl-4,6-diethyl-1,3-phenylene-diamine, 5-methyl-4,6-diethyl-1,3-phenylene-diamine, benzidine, 3,3′-dimethylbenzidine, 3,3′-dimethoxybenzidine, 1,5-diaminonaphthalene, bis(4-aminophenyl) methane, bis(2-chloro-4-amino-3,5-diethylphenyl) methane, bis(4-aminophenyl) propane, 2,4-bis(b-amino-t-butyl) toluene, bis(p-b-amino-t-butylphenyl) ether, bis(p-b-methyl-o-aminophenyl)benzene, bis(p-b-methyl-o-aminopentyl)benzene, 1,3-diamino-4-isopropylbenzene, bis(4-aminophenyl) ether and 1,3-bis(3-aminopropyl)tetramethyldisiloxane. Mixtures of these amines can be used. Illustrative examples of amine compounds of formula (10) containing sulfone groups include but are not limited to, diamino diphenyl sulfone (DDS) and bis(aminophenoxy phenyl) sulfones (BAPS). Combinations comprising any of the foregoing amines can be used.

The polyetherimides can be synthesized by the reaction of the bis(phthalimide) (8) with an alkali metal salt of a dihydroxy substituted aromatic hydrocarbon of the formula HO—V—OH wherein V is as described above, in the presence or absence of phase transfer catalyst. Suitable phase transfer catalysts are disclosed in U.S. Pat. No. 5,229,482. Specifically, the dihydroxy substituted aromatic hydrocarbon a bisphenol such as bisphenol A, or a combination of an alkali metal salt of a bisphenol and an alkali metal salt of another dihydroxy substituted aromatic hydrocarbon can be used.

In one embodiment, the polyetherimide comprises structural units of formula (5) wherein each R is independently p-phenylene or m-phenylene or a mixture comprising at least one of the foregoing; and T is group of the formula —O—Z—O— wherein the divalent bonds of the —O—Z—O— group are in the 3,3′ positions, and Z is 2,2-diphenylenepropane group (a bisphenol A group). Further, the polyetherimide sulfone comprises structural units of formula (6) wherein at least 50 mole % of the R groups are of formula (4) wherein Q is —SO₂— and the remaining R groups are independently p-phenylene or m-phenylene or a combination comprising at least one of the foregoing; and T is group of the formula —O—Z—O— wherein the divalent bonds of the —O—Z—O— group are in the 3,3′ positions, and Z is a 2,2-diphenylenepropane group.

The polyetherimide and polyetherimide sulfone can be used alone or in combination with each other and/or other of the disclosed polymeric materials in fabricating the polymeric components of the invention. In one embodiment, only the polyetherimide is used. In another embodiment, the weight ratio of polyetherimide:polyetherimide sulfone can be from 99:1 to 50:50.

The polyetherimides can have a weight average molecular weight (Mw) of 5,000 to 100,000 grams per mole (g/mole) as measured by gel permeation chromatography (GPC). In some embodiments the Mw can be 10,000 to 80,000. The molecular weights as used herein refer to the absolute weight averaged molecular weight (Mw).

The polyetherimides can have an intrinsic viscosity greater than or equal to 0.2 deciliters per gram (dl/g) as measured in m-cresol at 25° C. Within this range the intrinsic viscosity can be 0.35 to 1.0 dl/g, as measured in m-cresol at 25° C.

The polyetherimides can have a glass transition temperature of greater than 180 degrees Celsius, specifically of 200 to 500 degrees Celsius, as measured using differential scanning calorimetry (DSC) per ASTM test D3418. In some embodiments, the polyetherimide and, in particular, a polyetherimide has a glass transition temperature of 240 to 350 degrees Celsius.

The polyetherimides can have a melt index of 0.1 to 10 grams per minute (g/min), as measured by American Society for Testing Materials (ASTM) DI 238 at 340 to 370 degrees Celsius, using a 6.7 kilogram (kg) weight.

One process for the preparation of polyetherimides having structure (1) is referred to as the nitro-displacement process (X is nitro in formula (8)). In one example of the nitro-displacement process, N-methyl phthalimide is nitrated with 99% nitric acid to yield a mixture of N-methyl-4-nitrophthalimide (4-NPI) and N-methyl-3-nitrophthalimide (3-NPI). After purification, the mixture, containing approximately 95 parts of 4-NPI and 5 parts of 3-NPI, is reacted in toluene with the disodium salt of bisphenol-A (BPA) in the presence of a phase transfer catalyst. This reaction yields BPA-bisimide and NaNO₂ in what is known as the nitro-displacement step. After purification, the BPA-bisimide is reacted with phthalic anhydride in an imide exchange reaction to afford BPA-dianhydride (BPADA), which in turn is reacted with meta-phenylene diamine (MPD) in ortho-dichlorobenzene in an imidization-polymerization step to afford the product polyetherimide.

An alternative chemical route to polyetherimides having structure (1) is a process referred to as the chloro-displacement process (X is Cl in formula (8)). The chloro-displacement process is illustrated as follows: 4-chloro phthalic anhydride and meta-phenylene diamine are reacted in the presence of a catalytic amount of sodium phenyl phosphinate catalyst to produce the bischloro phthalimide of meta-phenylene diamine (CAS No. 148935-94-8). The bischloro phthalimide is then subjected to polymerization by chloro-displacement reaction with the disodium salt of BPA in the presence of a catalyst in ortho-dichlorobenzene or anisole solvent. Alternatively, mixtures of 3-chloro- and 4-chlorophthalic anhydride may be employed to provide a mixture of isomeric bischloro phthalimides which may be polymerized by chloro-displacement with BPA disodium salt as described above.

Siloxane polyetherimides can include polysiloxane/polyetherimide block copolymers having a siloxane content of greater than 0 and less than 40 weight percent (wt. %) based on the total weight of the block copolymer. The block copolymer comprises a siloxane block of Formula (I):

[chemical structure]

wherein R¹⁻⁶ are independently at each occurrence selected from the group consisting of substituted or unsubstituted, saturated, unsaturated, or aromatic monocyclic groups having 5 to 30 carbon atoms, substituted or unsubstituted, saturated, unsaturated, or aromatic polycyclic groups having 5 to 30 carbon atoms, substituted or unsubstituted alkyl groups having 1 to 30 carbon atoms and substituted or unsubstituted alkenyl groups having 2 to 30 carbon atoms, V is a tetravalent linker selected from the group consisting of substituted or unsubstituted, saturated, unsaturated, or aromatic monocyclic and polycyclic groups having 5 to 50 carbon atoms, substituted or unsubstituted alkyl groups having 1 to 30 carbon atoms, substituted or unsubstituted alkenyl groups having 2 to 30 carbon atoms and combinations comprising at least one of the foregoing linkers, g equals 1 to 30, and d is 2 to 20. Commercially available siloxane polyetherimides can be obtained from SABIC Innovative Plastics under the brand name SILTEM* (*Trademark of SABIC Innovative Plastics IP B.V.)

The polyetherimide resin can have a weight average molecular weight (Mw) within a range having a lower limit and/or an upper limit. The range can include or exclude the lower limit and/or the upper limit. The lower limit and/or upper limit can be selected from 5000, 6000, 7000, 8000, 9000, 10000, 11000, 12000, 13000, 14000, 15000, 16000, 17000, 18000, 19000, 20000, 21000, 22000, 23000, 24000, 25000, 26000, 27000, 28000, 29000, 30000, 31000, 32000, 33000, 34000, 35000, 36000, 37000, 38000, 39000, 40000, 41000, 42000, 43000, 44000, 45000, 46000, 47000, 48000, 49000, 50000, 51000, 52000, 53000, 54000, 55000, 56000, 57000, 58000, 59000, 60000, 61000, 62000, 63000, 64000, 65000, 66000, 67000, 68000, 69000, 70000, 71000, 72000, 73000, 74000, 75000, 76000, 77000, 78000, 79000, 80000, 81000, 82000, 83000, 84000, 85000, 86000, 87000, 88000, 89000, 90000, 91000, 92000, 93000, 94000, 95000, 96000, 97000, 98000, 99000, 100000, 101000, 102000, 103000, 104000, 105000, 106000, 107000, 108000, 109000, and 110000 daltons. For example, the polyetherimide resin can have a weight average molecular weight (Mw) from 5,000 to 100,000 daltons, from 5,000 to 80,000 daltons, or from 5,000 to 70,000 daltons. The primary alkyl amine modified polyetherimide will have lower molecular weight and higher melt flow than the starting, unmodified, polyetherimide.

The polyetherimide resin can be selected from the group consisting of a polyetherimide, for example as described in U.S. Pat. Nos. 3,875,116; 6,919,422 and 6,355,723 a silicone polyetherimide, for example as described in U.S. Pat. Nos. 4,690,997; 4,808,686 a polyetherimide sulfone resin, as described in U.S. Pat. No. 7,041,773 and combinations thereof, each of these patents are incorporated herein their entirety.

The polyetherimide resin can have a glass transition temperature within a range having a lower limit and/or an upper limit. The range can include or exclude the lower limit and/or the upper limit. The lower limit and/or upper limit can be selected from 100, 110, 120, 130, 140, 150, 160, 170, 180, 190, 200, 210, 220, 230, 240, 250, 260, 270, 280, 290, and 300 degrees Celsius. For example, the polyetherimide resin can have a glass transition temperature (Tg) greater than about 200 degrees Celsius.

The polyetherimide resin can be substantially free (less than 100 ppm) of benzylic protons. The polyetherimide resin can be free of benzylic protons. The polyetherimide resin can have an amount of benzylic protons below 100 ppm. In one embodiment, the amount of benzylic protons ranges from more than 0 to below 100 ppm. In another embodiment, the amount of benzylic protons is not detectable.

The polyetherimide resin can be substantially free (less than 100 ppm) of halogen atoms. The polyetherimide resin can be free of halogen atoms. The polyetherimide resin can have an amount of halogen atoms below 100 ppm. In one embodiment, the amount of halogen atoms range from more than 0 to below 100 ppm. In another embodiment, the amount of halogen atoms is not detectable.

In one embodiment, the polyetherimides include a polyetherimide thermoplastic resin composition, comprising: (a) a polyetherimide resin, and (b) a phosphorus-containing stabilizer, in an amount that is effective to increase the melt stability of the polyetherimide resin, wherein the phosphorus-containing stabilizer exhibits a low volatility such that, as measured by thermogravimetric analysis of an initial amount of a sample of the phosphorus-containing stabilizer, greater than or equal to 10 percent by weight of the initial amount of the sample remains unevaporated upon heating of the sample from room temperature to 300 degrees Celsius. at a heating rate of a 20 degrees Celsius per minute under an inert atmosphere. In one embodiment, the phosphorous-containing stabilizer has a formula P—Rₐ, where R′ is independently H, alkyl, alkoxy, aryl, aryloxy, or oxy substituent and is 3 or 4. Examples of such suitable stabilized polyetherimides can be found in U.S. Pat. No. 6,001,957, incorporated herein in its entirety.

The water borne formulations prepared from emulsion process can be used for multiple applications, including but not limited to formation of protective coatings and tie layers; wire, fiber or steel coatings; and forming films for electronic and electric applications.

The above water borne formulations can be modified in various ways. Cross linking agents can be added (for example, multifunctional amines) to improve the mechanical properties of the coating. Pigments, anti-static agents as well as fillers can be added to modify the coating properties. De-foaming agents can be added for making uniform films. The water-dispersed formulations can be blended with other latex-based polymers (for example, acrylic or urethane based polymers) to improve the properties. Polymer blends can be used to form the aqueous dispersion. Conductive fillers can be added for electronic and electrical applications. Coalescing agents such as N-methylpyrrolidone, glycols, glycol ethers dimethyl acetamide, tetrahydro furan, dimethyl formamide, dimethyl sulfoxide, anisole, pyridine, and the like, can be added. A co-solvent like furfuryl alcohol can also be added to the coalescing agent to reduce the viscosity and to improve the coating properties. Environmentally benign coalescing agents can be also used in these formulations. Multiple sandwich coatings can be employed involving high performance polymer coating (polyetherimide, polyethersulfone etc) and other water dispersed coatings (fluorinated polymer, polyolefin, polyurethane or polyacrylate etc) to achieve good mechanical and barrier properties.

A third embodiment relates to a method of producing surface cross-linked micronized particles and articles of polyetherimide. According to the third embodiment, immersing micronized particles of polyetherimide in 10% (w/v) of diamine in methanol for 1 hour or more at room temperature can produce micronized particles with cross-linked surfaces. The resulting particles exhibit high chemical resistance when compared to non-exposed particles. In a similar way, immersing injection molded or extruded polyetherimide articles in 10% (w/v) of diamine in methanol for 1 hour or more at room temperature produces articles with cross-linked surfaces. The resulting articles exhibit high chemical resistance when compared to non-exposed articles.

Various embodiments relate to a polymer coating on a substrate based on an aqueous polymer coating composition comprising micronized polymer particles and a surfactant having an HLB value within a range having a lower limit and/or an upper limit. The range can include or exclude the lower limit and/or the upper limit. The lower limit and/or upper limit can be selected from 5, 6, 7, 8, 9, 10, 11, 12, 13, 14, 15, 16, 17, 18, 19, 20, 21, 22, 23, 24, 25, 26, 27, 28, 29, and 30. For example, according to certain preferred embodiments, various embodiments relate to a polymer coating on a substrate based on an aqueous polymer coating composition comprising micronized polymer particles and a surfactant having an HLB value greater than 9.

The substrate can be made from at least one material from the group consisting of wood, metal, glass, carbon and plastic.

The coating can be formed by heating the coated article to a temperature within a range having a lower limit and/or an upper limit. The range can include or exclude the lower limit and/or the upper limit. The lower limit and/or upper limit can be selected from 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350, 355, 360, 365, 370, 375, 380, 385, 390, 395, and 400 degrees Celsius. For example, according to certain preferred embodiments, the coating can be formed by heating the coated article to a temperature of from 80 to 350 degrees Celsius.

A percentage of the polymer particles, based on volume, can have a particle size within a range having a lower limit and/or an upper limit. The range can include or exclude the lower limit and/or the upper limit. The lower limit and/or upper limit can be selected from 0.1, 0.5, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41,42, 43, 44, 45, 46, 47, 48, 49, and 50 micrometers. For example, according to certain preferred embodiments, a percentage of the polymer particles, based on volume, can have a particle size below 45 micrometers. The percentage by volume of the polymer particles can be within a range having a lower limit and/or an upper limit. The range can include or exclude the lower limit and/or the upper limit. The lower limit and/or upper limit can be selected from 80, 81, 82, 83, 84, 85, 86, 87, 88, 89, 90, 91, 92, 93, 94, 95, 96, 97, 98, and 99%. For example, according to certain preferred embodiments, the percentage by volume of the polymer particles, having a particle size below 45 micrometers, can be 90%.

Various embodiments relate to an aqueous polymer coating composition comprising micronized polymer particles and a surfactant with an HLB value within a range having a lower limit and/or an upper limit. The range can include or exclude the lower limit and/or the upper limit. The lower limit and/or upper limit can be selected from 5, 6, 7, 8, 9, 10, 11, 12, 13, 14, 15, 16, 17, 18, 19, 20, 21, 22, 23, 24, 25, 26, 27, 28, 29, and 30. For example, according to certain preferred embodiments, various embodiments relate to an aqueous polymer coating composition comprising micronized polymer particles and a surfactant with an HLB value of greater than or equal to 9.

The polymer coating can be cross-linked. The polymer particles can have a spherical morphology. The polymer particles can comprise polyetherimide. The polymer particles can comprise blends of polyetherimide and polyethersulfone. The polymer particles can comprise blends of polyetherimide, polyethersulfone and polyamideimide.

The surfactant concentration in the aqueous polymer coating composition can be within a range having a lower limit and/or an upper limit. The range can include or exclude the lower limit and/or the upper limit. The lower limit and/or upper limit can be selected from 0.5, 1, 1.5, 2, 2.5, 3, 3.5, 4, 4.5, 5, 10, 15, 20, and 25%. For example, according to certain preferred embodiments, the surfactant concentration can be greater than 1%.

The aqueous polymer coating composition can further comprise a polar organic solvent in an amount within a range having a lower limit and/or an upper limit. The range can include or exclude the lower limit and/or the upper limit. The lower limit and/or upper limit can be selected from 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41,42, 43, 44, 45, 46, 47, 48, 49, 50, 51, 52, 53, 54, 55, 56, 57, 58, 59, and 60%. For example, according to certain preferred embodiments, the aqueous polymer coating composition can further comprise a polar organic solvent in an amount of less than or equal to 50 wt. %.

The organic solvent can be at least one selected from the group consisting of N-methyl-2-pyrrolidone, dimethylacetamide, tetrahydrofuran or dimethylformamide. The aqueous polymer coating composition can further comprise at least one selected from the group consisting of cross linking agents, fillers and pigments.

Various embodiments relate to a polymer coating on a substrate based on aqueous polymer coating composition, further comprising one or more top layers. Various embodiments relate to a polymer thin film formed from an aqueous polymer coating composition comprising micronized polymer particles and a surfactant with an HLB value within a range having a lower limit and/or an upper limit. The range can include or exclude the lower limit and/or the upper limit. The lower limit and/or upper limit can be selected from 5, 6, 7, 8, 9, 10, 11, 12, 13, 14, 15, 16, 17, 18, 19, 20, 21, 22, 23, 24, 25, 26, 27, 28, 29, and 30. For example, according to certain preferred embodiments, various embodiments relate to a polymer thin film formed from an aqueous polymer coating composition comprising micronized polymer particles and a surfactant with an HLB value of greater than or equal to 9.

The film can be formed by heating the micronized particles to a temperature within a range having a lower limit and/or an upper limit. The range can include or exclude the lower limit and/or the upper limit. The lower limit and/or upper limit can be selected from 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350, 355, 360, 365, 370, 375, 380, 385, 390, 395, and 400 degrees Celsius. For example, according to certain preferred embodiments, the film can be formed by heating the micronized particles to a temperature of from 80 to 350 degrees Celsius.

The thin film can have a surfactant concentration within a range having a lower limit and/or an upper limit. The range can include or exclude the lower limit and/or the upper limit. The lower limit and/or upper limit can be selected from 0.5, 1, 1.5, 2, 2.5, 3, 3.5, 4, 4.5, 5, 10, 15, 20, 25, 30, 35, 40, 45, and 50%. For example, according to certain preferred embodiments, the thin film can have a surfactant concentration of greater than or equal to 1%.

The polymer particles of the thin film can comprise polyetherimide. The polymer particles of the thin film can comprise a blend of polyetherimide and polyethersulfone. The polymer particles of the thin film can comprise a blend of polyetherimide, polyethersulfone and polyamideimide.

The thin film can further comprise at least one selected from the group consisting of cross linking agents, fillers and pigments. The thin film can be cross-linked.

Various embodiments relate to an article comprising a substrate selected from wood, plastic, metal, glass and mixtures thereof, and at least one coating thereon formed from micronized particles selected from the group consisting of polyetherimide, polyethersulfone, blends thereof, and combinations thereof. Other embodiments relate to an article selected from cookware coating tie layers, epoxy toughening coatings, composite UD tapes, adhesives, a tie layer to bond metal and fluoropolymers, injection molded or extruded articles of soluble polymers coated with cross-linked coating of micronized particles, electrical conductors with coating formed from micronized particles, optical articles with micronized particle coatings, wood objects with a toughened coating formed from micronized particles, and carbon objects with a toughened coating formed from micronized particles.

The invention also can include other embodiments. In one embodiment, for instance, it is possible to produce continuous cross-linked PEI coated wire/glass/fiber articles as shown in FIG. 9. Initially, the PEI coated articles can be immersed in 10% (w/v) diamine solution in methanol. After a pre-determined time, the articles are immersed in methanol solution to remove any unreacted diamines. Heating the coated articles with an IR heater at 180 degrees Celsius removes the volatiles and produce the cross-linked PEI coated articles.

FIG. 9 shows a schematic process diagram of a process for producing surface cross-linked PEI coated wire/glass/fiber. A polyetherimide coated article 900 goes through a first immersion 901 in 10% (w/v) diamine solution in methanol followed by a second immersion 902 in methanol. After drying in a heater 903 to remove volatile organic compounds 904, the cross-linked PEI coated article 905 can be produced.

The invention is further described in the following illustrative examples in which all parts and percentages are by weight unless otherwise indicated.

### EXAMPLES

### Example 1

The purpose of this example was to demonstrate a process, according to the first embodiment, of making polyetherimide or polyethersulfone coated articles with an aqueous dispersion of micronized polyetherimide or polyethersulfone polymers.

### Description and Operation

An aqueous dispersion of micronized thermoplastic polymer with spherical morphology was produced by the following method: The thermoplastic polymer (Polyetherimide) was dissolved in an organic solvent like Methylene Chloride (between 25% and 1% concentration range) and emulsified with water (the water to organic ratio can be varied between 3:1 to 1:1 ratio w/w) using a surfactant like sodium dodecyl benzene sulfonate. Emulsification was done with high shear agitation (2500 rpm or above), which results in emulsion droplets of <45 microns. The organic solvent was removed from the solution either by heating or by purging with nitrogen. This results in aqueous dispersion of micronized thermoplastic polymer. In order to keep the residual organic content below 10 ppm, steam stripping was utilized where steam (150 lb) was introduced into the solution.

### Results

20% w/w polyetherimide (ULTEM® 1000 resin) solution in methylene chloride was prepared. Water was added to this polymer solution in 3:1 (w/w) ratio along with 3 weight percent of sodium dodecyl sulfonate surfactant (based on polyetherimide weight). The resulting solution was emulsified using a high shear agitator (Silverson Model L4R-PA) at 3000 rpm. Methylene chloride was removed from the emulsion by heating the solution at 80 degrees Celsius under vacuum. The residual organic solvent was removed by steam stripping using 150 lb steam purging through the solution. The SEM picture shown in FIG. 1, illustrates the spherical nature of the particles 100. These particles had an average particle diameter of 18 microns as per light scattering data. The aqueous dispersion of micronized thermoplastic polymer solution was passed through a 45 micron sieve to remove any bigger particles. In order to form a protective coating, a copper wire (6″ long with 0.025″ diameter) was dipped in the aqueous dispersion of polyetherimide (PEI). The wet copper wire was placed in an oven at 300 degrees Celsius for 15 min. The heating process removed the water as well as melted the polymer to form a uniform coating. The optical image of the coated wire 200 is shown in FIG. 2. The coating thickness was about 5.7 microns. The non-conductivity of electricity through the coating is confirmed by an ohmmeter by checking the conductance between exposed end and coated mid-section. As described above, articles can be coated by the aqueous dispersion of high performance thermoplastic polymers as illustrated in FIG. 3.

### Example 2

The purpose of this example was to demonstrate a process, according to the second embodiment, of making water-dispersed high performance polymers that can form a continuous film below 100 degrees Celsius.

### Description and Operation

An aqueous dispersion of micronized thermoplastic polymer with spherical morphology was produced by the following method: the thermoplastic polymer (Polyetherimide)) was dissolved in an organic solvent, specifically methylene chloride having a concentration in a range of from 25% and 1%. The dissolved thermoplastic polymer was then emulsified with water, using a surfactant like sodium dodecyl benzene sulfonate. The water to organic ratio can be varied between 3:1 to 1:1 ratio (w/w). Emulsification was done with high shear agitation at 2500 rpm or above, which resulted in stable emulsion formation. The organic solvent was removed from the solution by heating, spray drying, steam purging or by purging with a gas. This resulted in an aqueous dispersion of micronized thermoplastic polymer. The average diameter of the particles produced was lower than or equal to 75 microns. A coalescing agent, such as N-methyl pyrrolidone, was added to the above aqueous dispersion in levels of less than or equal to 100 percent by weight with respect to water weight. The water-dispersed polymer formulations were coated onto surfaces, such as glass and metal surfaces, and dried at room temperature (i.e., at about 23 degrees Celsius) to form a continuous film. Subsequently, the coated article or film was dried in an oven at less than or equal to 100 degrees Celsius for 48 hours in vacuum to remove volatile organic compounds (VOCs).

### Preparation of Polymer Aqueous Dispersion

A 20% w/w polyetherimide (ULTEM® 1000 resin) solution in methylene chloride was prepared in vessel 400 as shown in FIG. 4. Water was added to this polymer solution in 1:1 (w/w) ratio along with 3 weight percent of sodium dodecyl sulfonate surfactant (based on polyetherimide weight). The resulting solution was emulsified using a homogenizer 411, specifically, a Silverson Model L4R-PA at 2500 rpm as illustrated in FIG. 4. This resulted in a stable emulsion. Methylene chloride was removed from the emulsion by spray drying into water at degrees Celsius in spray drying vessel 402 as shown in FIG. 4, and the resulting aqueous dispersion was maintained at 80 degrees Celsius for three hours in order to remove any remaining amount of VOCs. The aqueous dispersion was passed through a 75 micron sieve to remove any bigger particles.

The scanning electron microscope (SEM) image shown in FIG. 5, illustrates the spherical nature of the formed polymer particles 500.

### Preparation of Water Dispersed Formulation

After cooling the aqueous dispersion to room temperature, a coalescing agent such as N-methylpyrrolidone (CAS #872-50-4) was added in different quantities (See: Table 1) based on the weight of water in the aqueous dispersion. The formulations were mixed well with a mechanical shaker.

### Protective Layer or Film Formation

The water borne formulations were applied to surfaces like glass and metal using a doctor's knife. Varying the percentage of solids in the water-dispersed formulation controlled the thickness of the coatings. The wet coating was allowed to dry at 23 degrees Celsius for about eight hours. The coated articles were further dried in vacuum oven (635 mm of Hg) for 48 hours at 90 degrees Celsius to remove any residual volatile organic compounds (VOCs).

Table 1 show that a formulation without any coalescing agent, did not form any film upon drying at temperatures below 100 degrees Celsius. Even with a minimum amount, such as 2.5 weight percent with respect to water weight, of coalescing agent, a continuous film can be formed.

TABLE 1
Film formation with various coalescing agent content

| | NMP* % | | | | |
|---|---|---|---|---|---|
| | with | Stability | Film | Film | |
| | respect to | of | formation | formation | Uniformity |
| Reaction # | water | emulsion | at 23° C. | <100° C. | of film |
| 1 | 0 | Stable | NO | NO | No film |
| (Control) | | | | | formation |
| 2 | 2.5 | Stable | YES | YES | Uniform film |
| 3 | 5 | Stable | YES | YES | Uniform film |
| 4 | 10 | Stable | YES | YES | Uniform film |
| 5 | 20 | Stable | YES | YES | Uniform film |
| 6 | 30 | Stable | YES | YES | Uniform film |

*NMP = N-methylpyrrolidone

Therefore, the compositions that are shown in Examples 2-6 were very useful for making films as well as protective coatings with low environmental impact. By contrast, the composition used in the control example was not useful for making uniform films.

### Examples 3-1, 3-2, 3-3, 3-4, 3-5, and 3-6

The purpose of these examples was to demonstrate a process, according to the third embodiment, of producing surface cross-linked micronized particles and articles of polyetherimide.

### Description and Operation

### Production of Micronized Particles of PEI Through Emulsion Process

The techniques for making powders that were used in 3-1, 3-2, 3-3, and subsequently crosslinked are described in the following section. Polyetherimide aqueous dispersions were made using method described earlier in Example 2 and passed through a 75 micron sieve to remove any bigger particles. The aqueous dispersion of micronized polyetherimide was filtered through a 10-micron filter. In order to keep the residual surfactant content below 25 ppm, the wet cake is washed thrice with de-ionized water and filtered. The final wet cake was dried in vacuum oven at 180 degrees Celsius for eight hours to remove water and residual organic solvents.

The powders could have also be jet-milling processes but jet-milling processes are ordinarily extremely expensive and the above-described method is preferred.

### Chemical Immersion of Polyetherimide Micronized Particles

For Examples 3-1, 3-2, and 3-3, micronized particles were immersed in 10% (w/v) of diamine in methanol for 1 hour at room temperature. Paraxylene diamine (PXDA) as well as diamino propyl capped methyl siloxane having 10 repeating siloxane units (G10) were chosen as representative diamines. After chemical exposure, the particles were filtered through 0.7-micron filter. The resulting powder was washed thrice with methanol to remove any unreacted residual diamines. The powder was dried at 180 degrees Celsius for eight hours to remove any residual volatile content.

### Chemical Immersion of Polyetherimide Articles of Examples 3-4, 3-5, and 3-6

Injection molded parts of polyetherimide used in Examples 3-4, 3-5, and 3-6 were immersed in 10% (w/v) of diamine in methanol for 1 hour at room temperature. Paraxylene diamine (PXDA), as well as, diamino propyl capped methyl siloxane, having 10 repeating siloxane units (G10), were chosen as representative diamines. After exposure, the molded parts were washed thoroughly with methanol to remove any unreacted diamines. The parts were dried at 180 degrees Celsius for eight hours to remove any residual volatile content.

### Techniques Modifying Particles by Crosslinking Particles and Articles Used in Examples 3-1, 3-1, 3-2, 3-3, and 3-4, 3-5, and 3-6

According to a third embodiment, micronized particles and articles of polyetherimide were immersed in 10% (w/v) of diamine in methanol for 1 hour at room temperature produces micronized particles and articles with cross-linked surfaces. The resulting particles and articles exhibited high chemical resistance when compared to non-exposed particles.

Table 2 summarizes the control sample as well as particles and articles that were subjected to crosslinking

TABLE 2

| Example | Material |
|---|---|
| 3.1 | Polyetherimide micronized particle |
| (Control) | |
| 3.2 | Polyetherimide micronized particle |
| | modified with PXDA |
| 3.3 | Polyetherimide micronized particle |
| | modified with G10 |
| 3.4 | Polyetherimide injection molded part |
| (Control) | |
| 3.5 | Polyetherimide injection molded |
| | part modified with PXDA |
| 3.6 | Polyetherimide injection molded |
| | part modified with G10 |

FIGS. 7 and 8 show the thermo-gravimetric analysis in air and nitrogen of these micronized particles used in Examples 3-1 and 3-2 and 3-3 summarized in the table above.

### Results

### Properties of Cross-Linked Micronized Particles of PEI

The micronized particles of polyetherimide, i.e., the control sample which was not cross linked, dissolves in chlorinated solvents like methylene chloride as shown in FIG. 6A and Table 3. Surprisingly, the micronized particles of polyetherimide that was immersed in 10% (w/v) of diamine in methanol for one hour did not completely dissolve in methylene chloride. The particles swelled in the solvent without complete dissolution as shown in FIG. 6B and as summarized in Table 3.

TABLE 3

| | | Dissolution in |
|---|---|---|
| Example | Material | Methylene Chloride |
| 3.1 | Polyetherimide micronized particle | Complete dissolution |
| 3.2 | Polyetherimide micronized particle | No full dissolution |
| | modified with PXDA | |
| 3.3 | Polyetherimide micronized particle | No full dissolution |
| | modified with G10 | |
| 3.4 | Polyetherimide injection molded part | Complete dissolution |
| 3.5 | Polyetherimide injection molded | No full dissolution |
| | part modified with PXDA | |
| 3.6 | Polyetherimide injection molded | No full dissolution |
| | part modified with G10 | |

The results summarized in Table 3 indicate that the surface of the micronized particles underwent cross-linking reaction that increased the chemical resistance of these particles.

More particularly, FIG. 7 shows a thermo gravimetric analysis of micronized polyetherimide particles (Examples 3-1, 3-2 and 3-3) in air. The control is shown as line 700. The sample immersed in 10% (w/v) of paraxylene diamine in methanol for 1 hour is shown as line 701. The sample immersed in 10% (w/v) of G10 in methanol for 1 hour is shown as line 702.

FIG. 8 shows a thermo gravimetric analysis of micronized polyetherimide particles (Examples 3-1, 3-2 and 3-3) in nitrogen. The control is shown as line 800. The sample immersed in 10% (w/v) of paraxylene diamine in methanol for 1 hour is shown as line 802. The sample immersed in 10% (w/v) of G10 in methanol for 1 hour is shown as line 801.

It can be seen that modification of the micronized particles by the diamine immersion did not affect the thermal stability of these particles. The cross-linked micronized particles are useful in applications that require improved chemical resistance.

### Properties of Cross-Linked Injection Molded Parts of Examples 3-4, 3-5, and 3-6

Injection molded polyetherimide (control samples which was not cross linked) articles completely dissolve in chlorinated solvents like methylene chloride. Surprisingly, the injection molded articles of polyetherimide that was immersed in 10% (w/v) of diamine in methanol for one hour did not completely dissolve in methylene chloride as shown in Table 3. The articles swell in the solvent without complete dissolution. This indicates that the surface of the articles underwent cross-linking reaction that increased the chemical resistance of these particles. The cross-linked polyetherimide articles are useful in applications that require improved chemical resistance.

Although the present invention has been described in considerable detail with reference to certain preferred versions thereof, other versions are possible. Therefore, the spirit and scope of the appended claims should not be limited to the description of the preferred versions contained herein.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C §112, sixth paragraph. In particular, the use of “step of” in the claims herein is not intended to invoke the provisions of 35 U.S.C §112, sixth paragraph.

What is claimed is:

1. A polymer coating on a substrate based on an aqueous polymer coating composition comprising micronized polymer particles and a surfactant with HLB value greater than 9.

2. A polymer coating on a substrate based on aqueous polymer coating composition according to claim 1, where the coating is formed by heating the coated article to a temperature of from 80 to 350 degrees Celsius.

3. The polymer coating on a substrate according to claim 1, where the substrate is made from at least one material from the group consisting of wood, metal, glass, carbon and plastic.

4. The polymer coating on a substrate defined in claim 1, wherein 90% of the polymer particles (based on volume) had a particle size below 45 micrometers.

5. An aqueous polymer coating composition comprising micronized polymer particles and a surfactant with HLB value >9, wherein 90% of polymer particles (based on volume) have particle size below 45 micrometers.

6. The aqueous polymer coating composition defined in claim 5, wherein the polymer particles are spherical in morphology.

7. The aqueous polymer coating composition defined in claim 5, wherein the surfactant concentration is >1%.

8. The aqueous polymer coating composition defined in claim 5, wherein polymer particles comprise polyetherimide.

9. The aqueous polymer coating composition defined in claim 5, wherein polymer particles comprise blends of polyetherimide and polyethersulfone.

10. The aqueous polymer coating composition defined in claim 5, wherein polymer particles comprise blends of polyetherimide, polyethersulfone and polyamideimide.

11. The aqueous polymer coating composition defined in claim 5, which further comprises a polar organic solvent in an amount of 50 wt. % or less, based onwater present in the composition.

12. The aqueous polymer coating composition defined in claim 11, wherein said organic solvent is at least one selected from the group consisting of N-methyl-2-pyrrolidone, dimethylacetamide, tetrahydrofuran or dimethylformamide.

13. The aqueous polymer coating composition defined in claim 5, which further comprises at least one selected from the group consisting of cross linking agents, fillers and pigments.

14. A polymer coating on a substrate based on aqueous polymer coating composition according to claim 5, further comprising one or more top layers.

15. A polymer thin film formed from an aqueous polymer coating composition comprising micronized polymer particles and a surfactant with HLB value >9.

16. The polymer thin film according to claim 15, where the film is formed by heating the micronized particles to a temperature between 80 deg C. and 350 deg C.

17. The thin film defined in claim 15, wherein the surfactant concentration is >1%.

18. The thin film defined in claim 15, wherein polymer particles comprise polyetherimide.

19. The thin film defined in claim 15, wherein polymer particles comprise a blend of polyetherimide and polyethersulfone.

20. The thin film defined in claim 15, wherein polymer particles comprise a blend of polyetherimide, polyethersulfone and polyamideimide.

21. The thin film defined in claim 15, which further comprises at least one selected from the group consisting of cross linking agents, fillers and pigments.

22. The polymer coating according to claim 1, wherein the coating is cross-linked.

23. The thin film according to claim 15, wherein the thin film is cross-linked.

24. An article comprising a substrate selected from the group consisting of wood, plastic, metal, glass and mixtures thereof, and at least one coating thereon formed from micronized particles selected from the group consisting of polyetherimide, polyethersulfone, blends thereof, and combinations thereof.

25. The article of claim 24, being one selected from the group consisting of cookware coating tie layers, epoxy toughening coatings, composite UD tapes, adhesives, a tie layer to bond metal and fluoropolymers, injection molded or extruded articles of soluble polymers coated with cross-linked coating of micronized particles, electrical conductors with coating formed from micronized particles, optical articles with micronized particle coatings, wood objects with a toughened coating formed from micronized particles, and carbon objects with a toughened coating formed from micronized particles.

26. A process for forming a coating or thin film of a polymer with reduced release of volatile organic components (VOC), the process comprising wetting a substrate with an aqueous dispersion of micronized thermoplastic powder having a spherical morphology and an average particle diameter of less than or equal to 45 microns, and thereafter heating the thermoplastic powder to a temperature of at least 300 degrees Celsius for at least 15 minutes.

27. The process of claim 26, wherein the thermoplastic powder is selected from the group consisting of polyetherimide, polyethersulfone, their copolymers, and blends.

28. The process of claim 26, wherein the substrate comprises a fiber material.

29. The process of claim 26, further comprising removing a thin film from the substrate.

30. The process according to claim 26, further comprising the step of drying the wetted substrate containing the micronized particles.

31. The process of claim 26, further comprising the step of cross-linking the micronized thermoplastic powder.

32. A product produced by the process of claim 26.

33. The polymer coating of claim 1, wherein the polymer is a composition comprising (a) a polyetherimide resin, and (b) a phosphorus-containing stabilizer, in an amount that is effective to increase the melt stability of the polyetherimide resin, wherein the phosphorus-containing stabilizer exhibits a low volatility such that, as measured by thermogravimetric analysis of an initial amount of a sample of the phosphorus-containing stabilizer, greater than or equal to 10 percent by weight of the initial amount of the sample remains unevaporated upon heating of the sample from room temperature to 300 degrees Celsius at a heating rate of a 20 degrees Celsius per minute under an inert atmosphere.

34. The polymer coating of claim 33, wherein the phosphorous-containing stabilizer has a formula P—Rₐ, where R′ is independently H, alkyl, alkoxy, aryl, aryloxy, or oxy substituent and a is 3 or 4.

35. The article of claim 24, wherein the polyetherimide is a composition comprising (a) a polyetherimide resin, and (b) a phosphorus-containing stabilizer, in an amount that is effective to increase the melt stability of the polyetherimide resin, wherein the phosphorus-containing stabilizer exhibits a low volatility such that, as measured by thermogravimetric analysis of an initial amount of a sample of the phosphorus-containing stabilizer, greater than or equal to 10 percent by weight of the initial amount of the sample remains unevaporated upon heating of the sample from room temperature to 300 degrees Celsius at a heating rate of a 20 degrees Celsius per minute under an inert atmosphere.

36. The article of claim 35, wherein the phosphorous-containing stabilizer has a formula P—Rₐ, where R′ is independently H, alkyl, alkoxy, aryl, aryloxy, or oxy substituent and is 3 or 4.

37. The process of claim 27, wherein the polyetherimide is a composition comprising (a) a polyetherimide resin, and (b) a phosphorus-containing stabilizer, in an amount that is effective to increase the melt stability of the polyetherimide resin, wherein the phosphorus-containing stabilizer exhibits a low volatility such that, as measured by thermogravimetric analysis of an initial amount of a sample of the phosphorus-containing stabilizer, greater than or equal to 10 percent by weight of the initial amount of the sample remains unevaporated upon heating of the sample from room temperature to 300 degrees Celsius at a heating rate of a 20 degrees Celsius per minute under an inert atmosphere.

38. The process of claim 37, wherein the phosphorous-containing stabilizer has a formula P—Rₐ, where R′ is independently H, alkyl, alkoxy, aryl, aryloxy, or oxy substituent and a is 3 or 4.
